(19) United States
(12) Patent Application Publication
(10) Pub. No.: US 2011/0302441 A1
(43) Pub. Date: Dec. 8, 2011

(54) CALCULATING POWER INPUT TO A COMPUTER

(76) Inventor: Thomas Sawyers, Hempstead, TX (US)

(21) Appl. No.: 13/202,032

(22) PCT Filed: Apr. 30, 2009
(86) PCT No.: PCT/US09/42238

§ 371 Date: Aug. 17, 2011

(51) Int. Cl. G06F 11/30

(52) U.S. Cl. 713/340

(57) ABSTRACT

One embodiment is a computer that includes a controller and a battery with a fuel gauge. The fuel gauge reports voltage and current input to charge the battery while the computer is in an off-state. The controller receives information about the voltage and current input to charge the battery from the fuel gauge and uses the information to calculate power being input to the computer while the computer is in an on-state.

### FIELD OF THE INVENTION

The present invention relates to a computer that includes a battery with a fuel gauge that reports voltage and current input to charge the battery while the computer is in an off-state so the computer can calculate input power while the computer is in an on-state.

### BACKGROUND

Some computers, such as personal computers and notebook computers, attempt to measure an amount of power being used. These measurements can be used to provide the user with useful information, such as information pertaining to battery charge expectancy and performance setting options.

These measurements, however, often include errors induced from circuits provided to measure power usage. As such, users can be presented with inaccurate information regarding performance and power usage.

### BRIEF DESCRIPTION OF THE DRAWINGS

FIG. 1 shows a flow diagram for calculating power consumption in a computer in accordance with an exemplary embodiment of the present invention.

FIG. 2A shows a graph of gain illustrating the effect of gain error in a fixed gain amplifier in accordance with an exemplary embodiment of the present invention.

FIG. 2B shows a graph of gain illustrating the effect of offset error in a fixed gain amplifier in accordance with an exemplary embodiment of the present invention.

FIG. 3 shows a computer system in accordance with an exemplary embodiment of the present invention.

FIG. 4 shows another embodiment of a computer system in accordance with an exemplary embodiment of the present invention.

### SUMMARY OF THE INVENTION

One embodiment is a computer that includes a controller and a battery with a fuel gauge. The fuel gauge reports voltage and current input to charge the battery while the computer is in an off-state. The controller receives information about the voltage and current input to charge the battery from the fuel gauge and uses the information to calculate power being input to the computer while the computer is in an on-state.

### DETAILED DESCRIPTION

Exemplary embodiments in accordance with the invention include apparatus and methods that accurately calculate power consumption in a computer. In one embodiment, circuitry within the computer senses current and then accurately calculates how much power is being drawn or consumed by the computer.

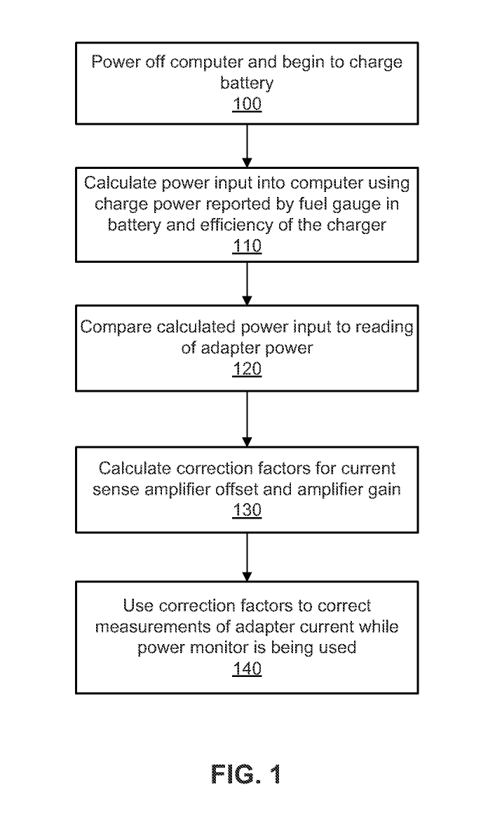

FIG. 1 shows a flow diagram for calculating power consumption in a computer in accordance with an exemplary embodiment of the present invention.

According to block 100, the computer is powered off to begin charging a battery of the computer. The battery is charged while the computer is in the off state so nearly all the power drawn by the computer is used to charge the battery. By way of example, this battery can be a permanent rechargeable battery in the computer or a removable battery in the computer, such as a replaceable battery pack that attaches to a notebook computer.

In block 100, two events are provided: off-state and charging the battery. The order of these events include first turning off the computer and then charging the battery, first beginning to charge the battery and then turning off the computer, or commencing these events at the same time.

According to block 110, power input into the computer is calculated using charge power reported by a fuel gauge in the battery and efficiency of a charger in the computer. In other words, the charge power reported by the battery's fuel gauge (which is very accurate) is used with an estimate of efficiency of the computer charger to calculate the power being input to the computer.

According to block 120, the calculated power being input to the computer is compared to a reading by the computer of AC adapter power.

According to block 130, calculations are made of correction factors for current sense amplifier offset and amplifier gain.

A large source of error is the computer's measurement of current supplied by the AC adapter. This error, in the past, has lead to inaccuracies in calculating power being consumed by the computer. Embodiments in accordance with the invention reduce or eliminate this error by calculating correction factors for current sense amplifier offset and amplifier gain.

In one exemplary embodiment, there are two pieces to the power monitor. First, there is hardware that collects data and a microcontroller with code that stores the data for future use. Second, there is a software application that reads the collected data, applies the correction factors (after the data has been collected), and outputs some information for use by the user. In this case, the data is collected continuously, but corrections and output are done while the machine is on and the power monitor software application is running. Data collection can also occur while the computer is in the off-state.

According to block 140, the correction factors are used to correct measurements of adapter current while a power monitor in the computer is being used (i.e., the computer is in a power-on state, as opposed to being powered-off). For example, these correction factors are stored then used to correct subsequent measurements of adapter current while the power monitor is used.

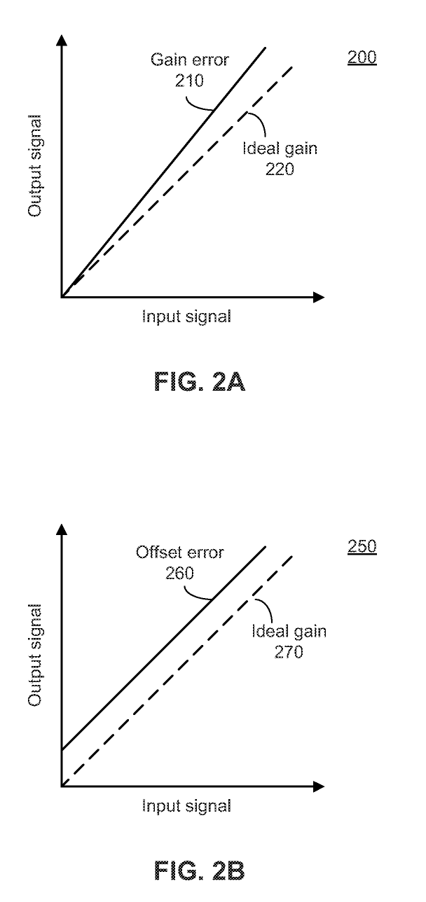

FIGS. 2A and 2B show graphs 200 and 250, respectively, of output signal (Y-axis) versus input signal (X-axis) for a fixed gain amplifier. FIG. 2A shows a plot of the ideal case 220 (i.e., ideal gain) and the case with gain error 210 for the fixed gain amplifier, and FIG. 2B shows a plot of the ideal case 270 (i.e., ideal gain) and the case with offset error 260 for the fixed gain amplifier. The cases with gain error 210 and with offset error 260 represent measured values of the amplifier whereas the ideal gains 220 and 270 represent values with no error (i.e., ideal or correct values with no measure-induced errors).

Exemplary embodiments in accordance with the invention identify or determine the gain error and offset error and then factor-out or remove these errors from readings of the fixed gain amplifier. As such, these error calculations are used to accurately determine power being consumed by the computer.

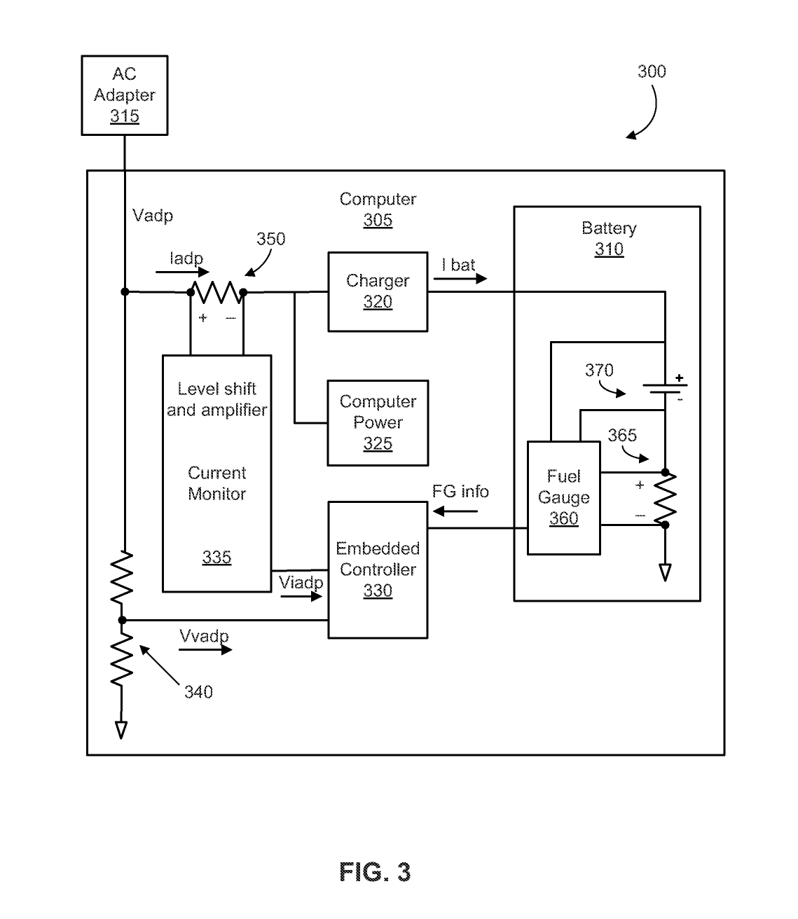

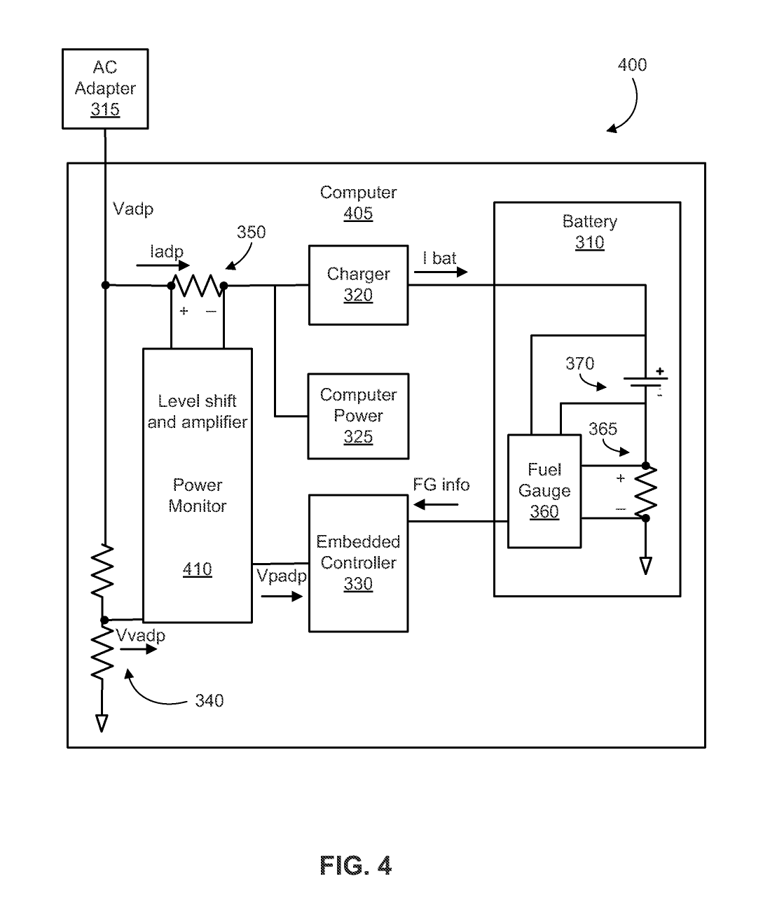

FIGS. 3 and 4 show exemplary embodiments of circuits and systems for calculating these errors and using correction factor to correct measurements of adapter current while power is being provided to the computer from an Alternating Current (AC) power source, such as an outlet.

FIG. 3 shows a computer system 300 that generally includes a computer 305, a battery 310, and an AC adapter 315. The computer includes various portable and non-portable electronic devices, such as, but not limited to, notebook or laptop computers, desktop computers, tablet computers, personal digital assistants (PDAs), or other portable and non-portable electronic devices or computers that include a re-chargeable battery.

The computer 305 includes a charger 320, computer power 325, an embedded controller 330, level shift and amplifier and current monitor 335, a voltage divider 340, and a high-side current sense resistor 350. The battery 310 includes a fuel gauge 360, a sense resistor 365, and rechargeable battery cells 370.

The high side current sense (CS) resistor 350 senses adapter current I_adp, and develops a voltage which is sensed by the level shift and amplifier circuit 335. The current I_adp going through the current sense resistor 350 produces a voltage that is measured by the circuit 335. The signal is amplified and level shifted to ground (i.e., to determine a voltage difference). This difference, as explained, is fed into the EC as V_iadpt.

This amplified signal represents current and is output to the embedded controller (EC) 330, shown as V_iadp flowing from the circuit 335 to EC 330. Adapter voltage V_adp is also sensed and sent into the EC 330, shown as V_vadp which represents voltage from the AC adapter. Thus, the EC 330 receives signals that represent both current and voltage of the AC adapter.

Adapter current (I_adp) multiplied by adapter voltage (V_adp) equals the input power to the computer. Some of this power goes to DC-DC converters that provide power to the computer, represented by the computer power block 325. If the battery 310 is charging, power is also delivered to the battery. As the charger may be a DC-DC converter, the charger 320 output current (I_bat) may be different than the charger input current.

When the AC adapter voltage (V_adp) is constant, the adapter current (I_adp) is proportional to adapter power. But to account for voltage drop under load and to ascertain the adapter voltage, the adapter voltage and the adapter current are both measured in the computer. These measurements are separately sent to the EC 330 (noted as V_iadp and V_vadp).

The battery 310 senses charger output current (I_bat), as well as battery voltage, using the fuel gauge 360. This fuel gauge is very accurate and is designed to track and report all energy entering or leaving the battery cells 370. The fuel gauge 360 is also designed to communicate information (shown as FG info) to the EC 330. By way of example, this information includes a percentage of charge, such as percent full.

When the computer 305 is in the off state, total power drawn by the computer is very low, typically under 50 mW. When the battery 310 charges in this off state, nearly all energy drawn from the AC adapter 315 is used to charge the battery 310. Voltage of the battery cells 370 and current input to these battery cells is accurately reported by the fuel gauge 360 to the EC 330. At heavy loads, the charger 320 is about 95% efficient and relatively little power is dissipated. When the charger efficiency versus load is characterized at the time of computer design and development, this efficiency is used to calculate an estimate for total power drawn into the computer. Only a few operating points are characterized. The current sense amplifier in the computer reports its measurement of current as well. The EC 330, system BIOS, or software can compare the current sense report to the estimated power level.

During a battery charge cycle, the power peaks just before the charge current begins to taper, typically 45 W for a 6 cell battery. At end of the charge, current to the same battery has reduced to about 250 mA, or about 3 W. At high load, the current sense signal is larger, and error is caused primarily by error in the amplifier gain (Av), and by the tolerance of current sense resistor 350. For a small sense signal, error is primarily caused by voltage offset in the amplifier (Vos).

During a charge cycle, when the battery 310 has been discharged below about 60%, charge power sweeps through the maximum power operating point, and down to the taper power operating point. This sweep provides an opportunity to compare computer CS amplitude readings to fuel gauge-based current estimates at two points, a high and a low signal level. From these comparisons, a calculation relating to computer amplifier Vos and actual gain Av are made. These values are stored in memory (for example, registers) and applied to correct subsequent readings made by the computer amplifier. In this manner, an existing low cost current sense amplifier, typically in the battery charger integrated circuit (IC), is made into a high precision sensor.

The following description provides an example embodiment as a notebook computer. During battery charge with the notebook in the off state, the charge voltage passes through 12.50V (on its way toward 12.6V) while the current is at its maximum level, which is measured as 3.574 A. At this High power point at time t1, adapter voltage and current are reported to the EC (Vadp1, Iadp1_measurement). The battery cells' voltage and current are also read at this time (Vbat1, Ibat1). Efficiency of the charger under these conditions has been previously characterized, so estimated efficiency of the charger (eff1) has been stored. Later in the charge cycle, the charge voltage is regulated to about 12.6V, and the charge current has tapered down to about 200 mA.

At some Low power point at time t2, adapter voltage and current are reported to the EC (Vadp2, Iadp_measurement, Vbat2, Ibat2), and efficiency at this state of charge has been previously characterized and stored (eff2). These data points are used to calculate actual voltage gain of the notebook current sense amplifier, and voltage offset of the same amplifier. Data reported from the battery is presumed accurate, as it is much more accurate than the notebook current sense. Power delivered to the notebook is estimated as charger power/charger efficiency. This accounts for all losses, as the efficiency was characterized by measuring notebook power draw in the off state since there is little variation in power draw in the off state. Power=voltage×current, so current=power/voltage. Assume at high power, eff1=0.951, Vbat1=12.50, Ibat1=3.574, then Padp1=12.50×3.574/0.951=46.92 W. If Vadp measured in the notebook was Vadp1=19.26, then Iadp1_calculated=Padp1/Vadp1=46.92/19.26=2.436 A.

The measurement of adapter current in the notebook is in the form of a voltage drop measured across a current sense resistor, then amplified and level shifted. This is Viadp in FIG. 3. The correct formula is Iadp_measurement signal=(Iadp×Rsense+Vos)×Av, where Vos is voltage offset of the current sense amplifier. Further, as shown below:

Iadp_measurement signal=(Iadp×Rsense+Vos)×Av

Iadp_measurement signal=(Iadp+Vos/Rsense)×(Av/Rsense)

Let offset=Vos/Rsense; and let Atotal=Av/Rsense

Then Iadp_measurement signal=(Iadp+offset)×Atotal.

In this example, ladp1_measurement signal=(Iadp+offset)×Atotal=0.8165 V.

This process is repeated for the low power point. If at low power, eff2=0.682, Vbat2=12.61, Ibat2=0.218, Vadp2=19.46, then Iadp2_calculated=Vbat2×Ibat2/Vadp2=4.031/19.46=0.2070 A. For measured current in the notebook, Iadp2_measurement signal=(Iadp+offset)×Atotal=0.04922 V. From these four data points—calculated high current 2.436 A and measured high CS signal 0.8165 V, calculated low current 0.2070 A and measured low CS signal 0.04922V—total gain and offset for this notebook can be derived to be Atotal=0.344, offset=−0.0640. These are stored for use as correction factors to the current sense data. As shown below:

CS voltage signal measured=(I_actual+offset)×Atotal=CS

Using Iadp_calculated for current I_actual, or I,

CS1=(I1+offset)×Atotal

CS2=(I2+offset)×Atotal

offset=(CS2×I1−CS1×I2)/(CS1−CS2)=−0.0640

Atotal=(CS1−CS2)/(I1−I2)=0.344.

After these factors are learned, they are applied to subsequent current measurements made in the notebook to achieve accurate measurement of notebook power for use as a wide range general purpose power monitor. To use this, read the current sense voltage measured, then

I_actual=CS voltage measured×(1/Atotal)−offset.

The large source of error is the efficiency of the charger at each point. Tolerances of notebook CS resistor, gain amplifier resistors, and even the adapter voltage sense divider resistors are trimmed out (i.e., removed), as the tolerance contributed by all these is accounted for in the total gain Atotal.

FIG. 4 shows another embodiment of a computer system 400 that generally includes a computer 405, a battery 310, and an AC adapter 315. The computer 405 is similar to the computer 305 shown in FIG. 3 with some difference (like numerals between the figures indicating like components).

In FIG. 4, output (V_vadp) from the voltage divider 340 is provided to the level shift and amplifier circuit and power monitor 410. V_padp from the power monitor 410 is then provided to the EC 330. Here, the EC 330 only receives a single power signal (as opposed to FIG. 3 in which the EC receives separate V_vadp and V_Iadp signals). As with the discussion of FIG. 3, the computer 405 of FIG. 4 also accounts for voltage drop under load and ascertains the adapter voltage, the adapter voltage and the adapter current. These measurements are not separately sent to the EC 330. Instead, V_adp is sent into a power monitor block, which outputs a single signal to the EC that represents adapter power.

With embodiments in accordance with the invention, a low cost current sense amplifier already in the computer design is used for a high performance power monitor function. No extra circuitry (beyond the minimum required to make a power monitor) is needed. This saves the cost of a precision amplifier and the cost and complexity (charge pump plus level shifter) of providing power to such an amplifier. This also saves the power that would be drawn by a precision amplifier and makes the computer more energy efficient in the off state. This further allows cancellation of the tolerances of the current sense resistor and any other resistors used in amplifying and delivering the signal to the EC, including the adapter voltage sense resistors. It does not require setting anything in the factory. The calibration can be accomplished automatically, without user intervention, during any battery charge cycle. Furthermore, exemplary embodiments do not require extra power switches or additional current sense resistors, which would otherwise be used to switch in a larger current sense resistor.

As explained, the correction factors for amplifier gain and offset errors are used to correct measurements of adapter current. These corrected measurements can be applied in a variety of manners. For example, the accurate and real-time power consumption can be presented or displayed to a user of the computer. Such information can include an amount of power being drawn or used with current computer settings and a cost analysis of usage at the current power usage rate. Further, the user can be provided through a graphical user interface and software with an opportunity to adjust performance options and power settings (such as turning down brightness of the display, changing power saving settings, changing processor performance, altering sleep or hibernation time periods, and making other changes to the computer's power plan).

### DEFINITIONS

As used herein and in the claims, the following words are defined as follows:

A “battery” is a device that stores energy that can be converted into electricity.

A “current sense resistor” is a resistor that converts current flowing to the resistor to a voltage drop that enables current through the resistor to be measured.

A “fuel gauge” is a device that measures an amount of energy stored in a battery.

A “voltage divider” is a linear circuit that produces an output voltage (Vout) that is a fraction of the input voltage (Vin).

In one exemplary embodiment, one or more blocks or steps discussed herein are automated. In other words, apparatus, systems, and methods occur automatically. The terms “automated” or “automatically” (and like variations thereof) mean controlled operation of an apparatus, system, and/or process using computers and/or mechanical/electrical devices without the necessity of human intervention, observation, effort and/or decision.

The methods in accordance with exemplary embodiments of the present invention are provided as examples and should not be construed to limit other embodiments within the scope of the invention. Further, methods or steps discussed within different figures can be added to or exchanged with methods of steps in other figures. Further yet, specific numerical data values (such as specific quantities, numbers, categories, etc.) or other specific information should be interpreted as illustrative for discussing exemplary embodiments. Such specific information is not provided to limit the invention.

In the various embodiments in accordance with the present invention, embodiments are implemented as a method, system, and/or apparatus. As one example, exemplary embodiments and steps associated therewith are implemented as one or more computer software programs to implement the methods described herein. The software is implemented as one or more modules (also referred to as code subroutines, or “objects” in object-oriented programming). The location of the software will differ for the various alternative embodiments. The software programming code, for example, is accessed by a processor or processors of the computer or server from long-term storage media of some type, such as a CD-ROM drive or hard drive. The software programming code is embodied or stored on any of a variety of known media for use with a data processing system or in any memory device such as semiconductor, magnetic and optical devices, including a disk, hard drive, CD-ROM, ROM, etc. The code is distributed on such media, or is distributed to users from the memory or storage of one computer system over a network of some type to other computer systems for use by users of such other systems. Alternatively, the programming code is embodied in the memory and accessed by the processor using the bus. The techniques and methods for embodying software programming code in memory, on physical media, and/or distributing software code via networks are well known and will not be further discussed herein.

The above discussion is meant to be illustrative of the principles and various embodiments of the present invention. Numerous variations and modifications will become apparent to those skilled in the art once the above disclosure is fully appreciated. It is intended that the following claims be interpreted to embrace all such variations and modifications.

What is claimed is:

1) A computer, comprising:
a battery including a fuel gauge that reports voltage and current input to charge the battery while the computer is in an off-state; and
a controller that receives information about the voltage and current input to charge the battery from the fuel gauge, wherein the controller uses the information to calculate power being input to the computer while the computer is in an on-state.

2) The computer of claim 1 further comprising:
a current sense resistor and an amplifier that provide to the controller a signal representing current supplied to the computer from an alternating current (AC) adapter;
a voltage divider that provides to the controller a signal representing a voltage supplied to the computer from the AC adapter.

3) The computer of claim 1 further comprising an amplifier, wherein the controller calculates a gain for an amplifier system and an offset for the amplifier system and uses the gain and offset to correct measurements of current input to the computer from an adapter.

4) The computer of claim 1, wherein the controller calculates power input into the computer from the voltage and current sensed in the computer.

5) The computer of claim 1, wherein the fuel gauge tracks and reports energy entering and leaving battery cells and reports information to the controller.

6) The computer of claim 1, wherein the controller compares amplitude readings from a current sense resistor to estimates of current from the fuel gauge at two signal levels to calculate errors in amplifier gain and errors in amplifier offset.

7) The computer of claim 1 further comprising an amplifier, wherein the controller uses correction factors relating to errors in amplifier gain and errors in amplifier offset to correct readings made by the amplifier.

8) A method, comprising:
calculating, with a fuel gauge in a battery of a computer, current and voltage input into the computer to charge the battery;
calculating, with a controller in the computer, correction factors for gain error and offset error; and
correcting, with the controller in the computer using the correction factors, measurements of power consumed by the computer.

9) The method of claim 8 further comprising:
receiving the current and voltage to charge the battery while the computer is in an off-state;
measuring a current supplied to the computer while the computer is in an on-state.

10) The method of claim 8 further comprising, reporting, from the fuel gauge to the controller, current and voltage input into the computer to charge the battery.

11) The method of claim 8 further comprising, eliminating the gain and offset error from measurements of the current and voltage.

12) The method of claim 8 further comprising:
providing to the controller a signal representing current supplied to the computer from an alternating current (AC) adapter;
providing to the controller a signal representing a voltage supplied to the computer from the AC adapter.

13) The method of claim 8 further comprising, comparing amplitude readings from a current sense resistor to estimates of current from the fuel gauge to calculate the gain error and the offset error.

14) The method of claim 8 further comprising:
calculating, with the controller, power input into the computer from a voltage and current sensed in the computer; and
correcting calculations of the power with the correction factors.

15) A computer system, comprising:
a battery including a fuel gauge that calculates power delivered to charge the battery; and
a computer connected to the battery and including a controller that receives information about the power from the fuel gauge, wherein the controller uses the information and correction factors to calculate power consumed by the computer.

16) The computer system of claim 15 further comprising:
a current sense resistor that senses current from an adapter;
a level shift and amplifier circuit that develops a voltage sensed from the current, wherein readings of the current and the voltage are provided to the controller to calculate power consumed by the computer.

17) The computer system of claim 15, wherein the correction factors include a gain of a fixed gain amplifier and an offset of the fixed gain amplifier.

18) The computer system of claim 15 further comprising:
a current sense resistor that converts current to a voltage drop that enables current through the current sense resistor to be measured and provided to the controller;
a voltage divider produces an output voltage that is a fraction of an input voltage and provided to the controller;
a power monitor that provides to the controller a power signal indicative of power being consumed by the computer while the computer is in an on-state.

19) The computer system of claim 15, wherein the controller compares amplitude readings from a current sense resistor to estimates of current from the fuel gauge to calculate the correction factors as errors in amplifier gain and errors in amplifier offset.

20) The computer system of claim 15, wherein the fuel gauge calculates the power delivered to charge the battery while the computer is in an off-state so nearly all energy drawn from an adapter is used to charge the battery.
